(19) United States
(12) Patent Application Publication
(10) Pub. No.: US 2017/0103389 A1
(43) Pub. Date: Apr. 13, 2017

(54) Electronic Payment Validation and Authorization System

(71) Applicant: Aerius, Inc., Boulder, CO (US)

(72) Inventors: Harry John Sorensen, Centenniel, CO (US); Jesse Daniel Taylor, Boulder, CO (US)

(21) Appl. No.: 15/289,079

(22) Filed: Oct. 7, 2016

Related U.S. Application Data
(60) Provisional application No. 62/238,118, filed on Oct. 7, 2015.

(51) Int. Cl. G06Q 20/38; G06Q 20/10; G06Q 20/40

(52) U.S. Cl. CPC G06Q 20/3829; G06Q 20/401; G06Q 20/102; G06Q 2220/00

(57) ABSTRACT

A system for performing electronic payment validation and authorization wherein a user of an electronic device transmits transaction data to an electronic payment validation and authorization system. The same user of the electronic device may nearly simultaneously transmit a cryptographic hash of transaction data to a merchant who uses a payment processing system to process the transactions. In this example, the payment-processing system may be an electronic payment system operated by the merchant and configured to accept transaction data generated by an electronic device. A payment processing system may cryptographically sign the hash and send the resulting data to an electronic payment validation and authorization system. After both data parts are received by an electronic payment validation and authorization system, validation and decryption may be performed and new transaction data which may include the user card data may then be sent to a payment processing system. The results of the transaction may then be sent to an electronic payment validation and authorization system and a merchant.

### CROSS REFERENCE TO RELATED APPLICATIONS

This application claims the benefit of U.S. Provisional Patent Application No. 62/238,118, filed on Oct. 7, 2015, also titled “Electronic Payment Validation and Authorization System” which is incorporated by reference herein in its entirety for all purposes.

### BACKGROUND OF THE INVENTION

The following publications are believed to represent the current state of the art: U.S. Pat. Nos. 7,210,622; 7,310,729; 7,660,296; 7,672,873; 7,711,647; 7,743,132; and U.S. Published Patent Application Nos.: 2011/0153380 and 2004/0093419.

### FIELD OF THE INVENTION

The present invention relates generally to secure transaction systems and methodologies.

### SUMMARY

The scope of the present invention is defined solely by the appended claims and detailed description of a preferred embodiment, and is not affected to any degree by the statements within this summary. In addressing many of the problems experienced in the related art, such as those relating to securing customer information, the present disclosure generally involves encryption and compartmentalization of sensitive data related to processing credit card transactions. More particularly, this invention defeats replay attacks against client devices and leaves stolen database records useless to malicious actors.

### BRIEF DESCRIPTION OF THE DRAWINGS

The above, and other, aspects, features, and advantages of several embodiments of the present disclosure will be more apparent from the following Detailed Description as presented in conjunction with the following several figures of the Drawing.

### Figures

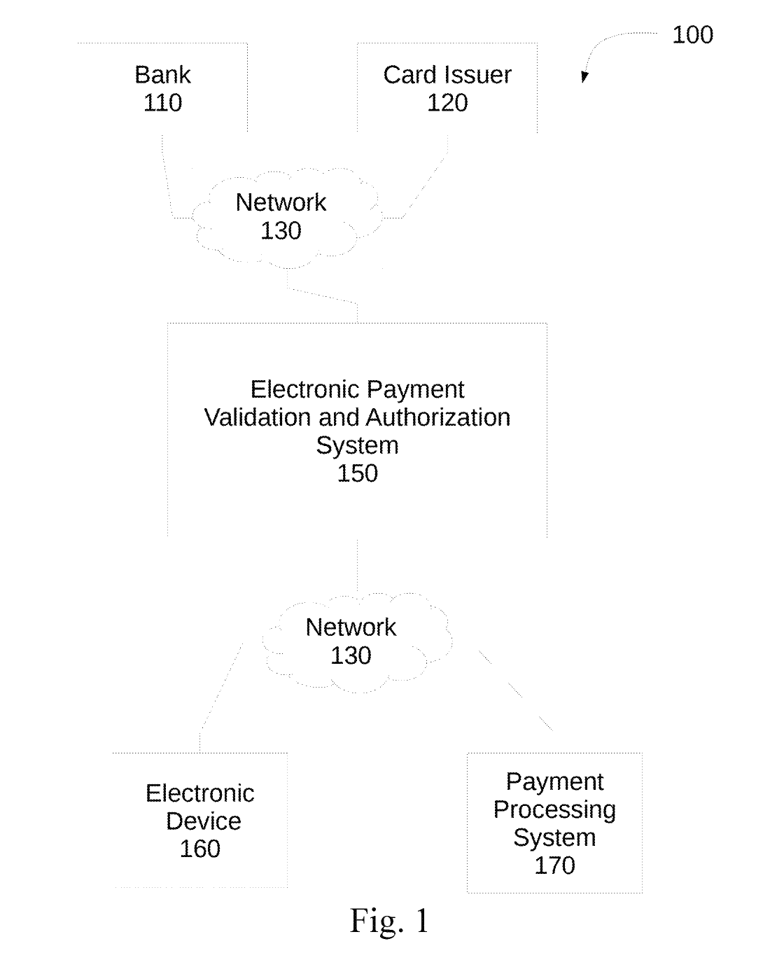

FIG. 1 illustrates a system for performing electronic payment validation and authorization, in accordance with an embodiment of the present disclosure.

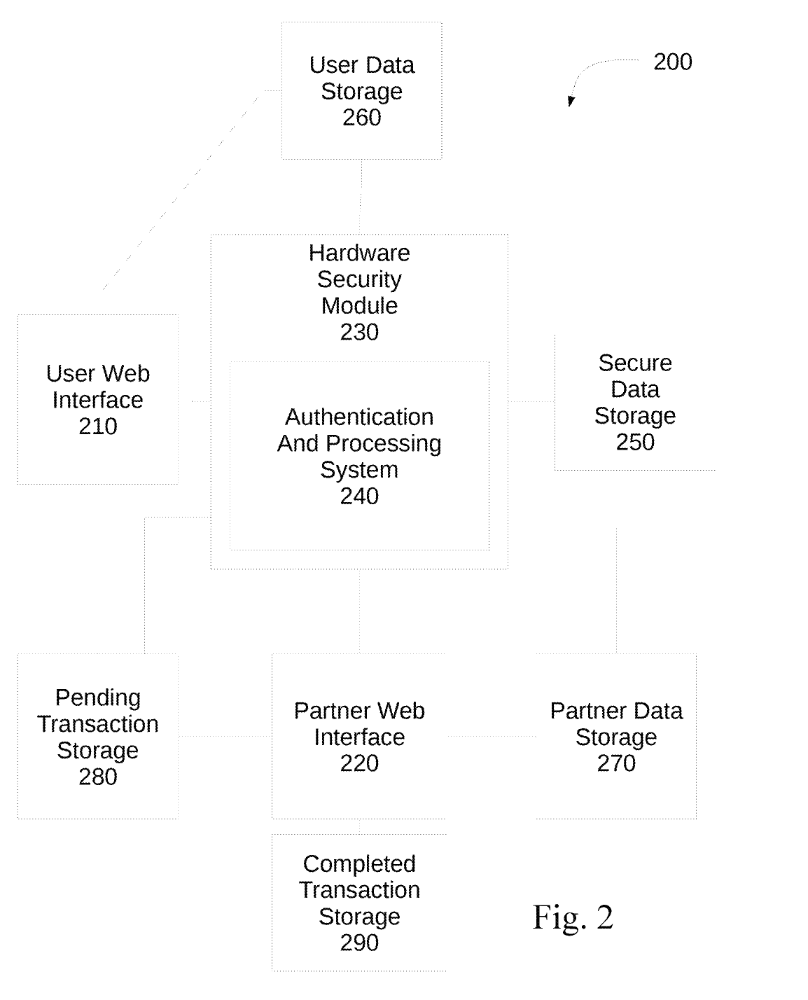

FIG. 2 illustrates individual modules in a system and how they interconnect, in accordance with an embodiment of the present disclosure.

Corresponding reference characters indicate corresponding components throughout the several figures of the Drawings. Also, common, but well-understood elements that are useful or necessary for commercially feasible embodiments are often not depicted in order to facilitate a less obstructed view of these various embodiments of the present disclosure.

### REFERENCES

100 A system
110 A bank
120 A card issuer
130 A network
150 An electronic payment validation and authorization system
160 User Device
170 Payment processing system
200 Sub-system
210 User web interface
220 Partner web interface
230 Hardware security module
240 Authentication service
250 Secure data service
260 User data storage
270 Partner data storage
280 Pending transaction data storage
290 Completed transaction data storage

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known methods, or operations are not shown or described in detail to avoid obscuring aspects of the present disclosure. Any alterations and further modifications in the illustrated systems, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same.

Financial transactions between merchants and customers are often performed using payment cards such as credit cards, debit cards, prepaid cards, ATM cards, and/or gift cards having magnetic stripes. Payment cards are often read or processed using a Point of Sale (POS) device, a POS terminal, or POS system. POS terminals are also used to perform other functions in addition to the reading and processing of payment cards, such as; for example: scanning bar codes on products, retrieving product prices, calculating transaction amounts, and computing taxes. POS devices have historically been the target of thieves who install software on the POS device or terminal to record the data traffic that passes through the device. This has led to a series of breaches of credit card data security that has cost consumers and banks billions of dollars in fraudulent transactions.

FIG. 1 illustrates an embodiment of a system 100 for performing electronic payment validation and authorization in accordance with the techniques introduced herein. An embodiment of a system for performing electronic payment validation and authorization 100 comprises one or more or one or more of the following: a bank 110, a card issuer 120, a network 130, an electronic payment validation and authorization system 150, an electronic device 160, and a payment processing system 170. The system 100 may also include other devices or systems involved in the processing of the payment.

A bank 110 may be any financial institution that provides user access to funds stored. A card issuer 120 may be any company that issues credit cards. A network 130 may comprise any apparatus, device, system, firmware, software, or combination thereof for communicating digitized data from one location to another. A network 130 may include an intranet, the Internet, a local area network (LAN), a wide area network (WAN), a wireless network, a Wi-Fi® network, a cellular network, a cellular data network, near field communication (NFC), Bluetooth, or any other electronic communication path, including equivalents or combinations thereof. A network 130 may also include devices such as servers, switches, routers, and gateways. The devices and systems of FIG. 1 are illustrated as communicating over a single network, network 130; however, communications between the devices and systems may be conducted over multiple networks, separate networks, and/or various combinations of networks, including wireless networks.

An electronic payment validation and authorization system 150 may be a system for authenticating transactions submitted by users through an electronic device 160. This electronic payment validation and authorization system 150 may validate that the transaction was authorized by a user device 160 using a public key cryptography or similar process and may retrieve encrypted card data to be passed through a network 130 to a payment processing system 170. An electronic payment validation and authorization system 150 may comprise multiple computers, data storage devices, and hardware encryption modules.

An electronic device 160 may be any handheld, mobile, or stationary computing device such as: a cellular phone, a mobile phone, a smartphone, a tablet computer, a notebook computer, a desktop computer, an Internet access device, a Wi-Fi® access device, an electronic book reader, a personal digital assistant (PDA), a phablet, a GPS receiver, an audio player, a multimedia player, or any other similar device. A user electronic device 160 may be capable of storing account information related to an electronic payment validation and authorization system account in an electrical, electronic, or digital memory. In some cases, the memory may be in the form of a card or module that is readable by an electronic device 110 and may be removed from an electronic device 160.

The stored account information may comprise an account number or an account identifier of some type and a private and public key pair. In some cases, the account information may also include a name of the owner or party responsible for the account. The account information may also include other data. For example, the account information may include key rotation details or pending card activation requests. The account information may also include data related to an account balance, transaction history, expiration, or other data related to use of funds associated with the account. The account information may be received by mobile electronic device 110 through manual entry at the user interface of a mobile electronic device 110, it may be loaded via a removable memory device, it may be received from another device over a wired connection, or it may be received from another device through a wireless connection such as; for example, through a cellular phone data network or a Wi-Fi® access point.

A payment processing system 170 comprises any system, or portion of a system, for processing financial transactions or financial transaction requests. A payment processing system 170 may be one or more of one or more of the following: a computer, a group of computers, a server, a group of servers, a mainframe, an application specific computing device, a distributed computing system, a portion of a distributed computing system, or a combination thereof. In the credit card processing industry, an entity operating a payment-processing system 170 may be referred to as an “acquirer” and/or may perform some or all of the same functions as an acquirer.

Payment processing systems 170 may be configured for performing a number of different aspects of processing a payment, such as: receiving transaction information from a merchant, sending a request to a card issuer, receiving authorizations from card issuers (e.g., banks, credit unions), transmitting authorizations to merchants, processing batches of authorized transactions from merchants, communicating with card networks (e.g., Visa®, American Express®), and/or settling transactions. Many different processes and systems are possible for processing credit, debit, and electronic payments; these processes and systems may involve: banks, acquiring banks, card issuers, card networks, and other financial entities in various combinations.

In one embodiment of the operation of an embodiment of the present system 100: a user of an electronic device 160 transmits transaction data to an electronic payment validation and authorization system 150. The same user of the electronic device 160 may nearly simultaneously transmit a cryptographic hash of transaction data to a merchant who uses a payment processing system 170 to process the transactions. In this example, the payment-processing system 170 may be an electronic payment system operated by the merchant and configured to accept transaction data generated by an electronic device 160. A payment processing system may 170 cryptographically sign the hash and send the resulting data to an electronic payment validation and authorization system 150. After both data parts are received by an electronic payment validation and authorization system 150, validation and decryption may be performed and new transaction data which may include the user card data may then be sent to a payment processing system 170. The results of the transaction may then be sent to an electronic payment validation and authorization system 150 and a merchant.

FIG. 2 illustrates an embodiment of system 150 in accordance with the techniques introduced herein. Sub-system 200 may comprise one or more of one or more of the following: a user web interface 210, a partner web interface 220, a hardware security module 230, an authentication service 240, a secure data service 250, a user data storage 260, a partner data storage 270, a pending transaction data storage 280, and/or a completed transaction data storage 290.

In one example of user provisioning, a consumer contacts a bank 110 to set up a user account on system 150 to store account data: such as, but not limited to: credit card data. The bank may use a partner web interface 220 to submit account data and a personal identification number (PIN) or password. A partner web interface 220 may validate the bank's 110 identity using data stored in the partner data storage 270. If validation succeeds, the data may be passed on to an authentication and processing system 240. A new user account may be created in a user data storage 260 that comprises a user ID and random string (salt) among other items. The PIN or password, user salt and a secret salt stored in the hardware security module 230 may then be combined and cryptographically hashed to generate a symmetric encryption key. The card data may be encrypted using the generated symmetric encryption key and stored in secure data storage 250. The user ID may then be returned to the partner web interface 220.

In one example of user activation, a user may use an electronic device 160 to contact a user web interface 210. The user web interface 210 may query user data storage 260 for pending cards. The user may provide a card ID and PIN or password given by a bank 110 to a user web interface 210 as well as their personal PIN or password in an encrypted string. This may then be passed to an authentication and processing system 240 which may then be decrypted by a hardware security module 230. The salt may then be retrieved from user data storage 260 and combined with a PIN or password and the secret salt stored in the hardware security module 230 then cryptographically hashed to generate a symmetric encryption key. The card data may be retrieved from secure data storage 250 and decrypted with the generated symmetric encryption key. A new symmetric encryption key may then be generated from the user salt, new personal password and secret salt. The card data may then be encrypted with the new symmetric encryption key and stored in secure data storage 250.

In one example of processing a transaction, A user may use an electronic device 160 to send a user web interface one or more of one or more of the following: an amount, a PIN, a timestamp, and/or a merchant ID encrypted using cipher block chaining (CBC) or equivalent, and/or a system public key. This data may be stored in a pending transaction storage 280. Within a short time of the first data transmission an electronic device 160 may send a cryptographic hash of the first data to a payment processing system 170. The hash may be signed by a payment processing system 170 and sent to a partner web interface 220. The partner web interface 220 may then validate the payment processing system's 170 identity using a data stored in partner data storage 270 and encryption functionality provided by a hardware security module 230. If validation succeeds, the data is passed to an authentication and processing system 240. Once the encrypted data sent from electronic device 160 arrives in a pending transaction storage 280 it may be decrypted by a hardware security module 230. Validation may then be performed on one or more of the following: a timestamp, a customer, and/or a merchant ID by an authentication and processing system 240. If all checks pass, the user ID and salt may be retrieved from user data storage 260. The user salt, PIN or password and secret salt stored in the hardware security module 230 may then be combined and cryptographically hashed to generate a symmetric encryption key. The card data may be retrieved from secure data storage 250, decrypted using the generated symmetric encryption key and returned to a payment processing system 170 along with an amount of transaction and/or other data through a partner web interface 220. The results of the transaction may be sent from a payment processing system 170 to a partner web interface 220. The partner web interface 220 may then validate the payment processing system's 170 identity using data stored in the partner data storage 270 and encryption functionality provided by hardware security module 230. If validation succeeds, the transaction data may be moved from pending transaction storage 280 into completed transaction storage 290.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A system for performing electronic payment validation and authorization comprising an electronic device; wherein said electronic device generates a public and private key pair and transmits said public key along with original user information to an electronic payment validation and authorization system; wherein said electronic payment validation and authorization system generates salt from said user information and encrypts said user information and said salt into a electronic payment validation and authorization system private key which is then stored in said electronic payment validation and authorization system along with said public key generated by said electronic device.

2. The system for performing electronic payment validation and authorization of claim 1, wherein said electronic device uses said private key to encrypt additional information into a transactional message and sends said encrypted transactional message to said electronic payment validation and authorization system.

3. The system for performing electronic payment validation and authorization of claim 2, wherein said electronic device also sends said encrypted transactional message to another electronic device or an electronic payment-processing system.

4. The system for performing electronic payment validation and authorization of claim 3, further comprising an electronic payment-processing system wherein said electronic payment-processing system generates a public and private key pair and transmits said public key along with original user information to an electronic payment validation and authorization system; wherein said electronic payment validation and authorization system generates salt from said user information and encrypts said user information and said salt into a electronic payment validation and authorization system private key which is then stored in said electronic payment validation and authorization system along with said public key generated by said electronic payment-processing system.

5. The system for performing electronic payment validation and authorization of claim 4, wherein said electronic payment-processing system uses said private key to encrypt additional information into a electronic payment-processing system transactional message and sends said encrypted payment-processing system transactional message to said electronic payment validation and authorization system.

6. The system for performing electronic payment validation and authorization of claim 5, wherein said additional information comprises said encrypted transactional message from said electronic device.

7. The system for performing electronic payment validation and authorization of claim 6, wherein both said encrypted transactional message and said encrypted payment-processing system transactional message are sent to said electronic payment validation and authorization system; wherein said electronic payment validation and authorization system decrypts both messages using said electronic device public key and said payment-processing system public key.

8. The system for performing electronic payment validation and authorization of claim 7, wherein said electronic payment validation and authorization system validates the transactional data and new transaction data, which includes payment information, is then sent to an electronic payment-processing system.

9. The system for performing electronic payment validation and authorization of claim 7, wherein two encrypted transactional messages are sent to said electronic payment validation and authorization system; wherein said electronic payment validation and authorization system decrypts both messages using two of said electronic device public keys.

10. The system for performing electronic payment validation and authorization of claim 9, wherein said electronic payment validation and authorization system validates the transactional data and new transaction data, which includes payment information, is then sent to an electronic payment-processing system.
